(19) United States
(12) Patent Application Publication
(10) Pub. No.: US 2004/0239832 A1
(43) Pub. Date: Dec. 2, 2004

(54) Liquid crystal display device

(76) Inventor: Ken Saito, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/802,857

(22) Filed: Mar. 18, 2004

(30) Foreign Application Priority Data
Mar. 18, 2003 (JP) 2003-072990

(51) Int. Cl. G02F 1/1347

(52) U.S. Cl. 349/74

(57) ABSTRACT

In a liquid crystal display device, an uneven-surface structure is formed on a portion of a second main surface of a light guide plate which faces a sub liquid crystal display panel and light which is propagated in the light guide plate is reflected toward a first main surface of the light guide plate which faces a main liquid crystal display panel. The reflectance of the uneven-surface structure is corrected by changing the shape (level difference with respect to the second main surface, the area and the density in the inside of the second main surface) of the uneven-surface structure in the portion where the second main surface faces the sub liquid crystal display panel, whereby it is possible to suppress local lowering of brightness of the first main surface attributed to the radiation of light from the portion of the second main surface which becomes a cause of brightness irregularities.

### BACKGROUND OF THE INVENTION

The present invention relates to a liquid crystal display device (two-face liquid crystal display device), which is preferably mounted on a foldable mobile phone or the like and includes a main liquid crystal display panel and a sub liquid crystal display panel having a screen that is smaller than the screen of the main liquid crystal display panel; and, more particularly, the invention relates to a liquid crystal display device that is provided with a lighting device which is suitable for reducing brightness irregularities on the screen of the main liquid crystal display panel.

Along with downsizing of a mobile phone or a PDA (portable digital assistant) provided with a liquid crystal display panel, a mobile phone or a PDA having a design which allows a key pad part and a liquid crystal display panel to be folded during a non-calling time (a waiting time) has been commercialized. Further, recently, a product has been developed in which a miniaturized panel, which can display information even in a state in which a foldable mobile phone or PDA is folded (non-calling time), is arranged on a back side of the above-mentioned liquid crystal display panel. As a liquid crystal display device (a liquid crystal display module) which is suitable for use as a mobile phone or PDA that is provided with a second liquid crystal display panel (also referred to as a sub liquid crystal display panel or a sub panel) in addition to the conventional liquid crystal display panel (also referred to as a main liquid crystal display panel or a main panel), a product has been developed which is referred to as a “both-surface” liquid crystal display device in which two liquid crystal display panels are arranged at respective sides of one lighting device (also referred to as a back light system) and in which light is irradiated to the respective liquid crystal display panels using the lighting device. Such a both-surface liquid crystal display device and the mobile phone in which the liquid crystal display device is mounted are described in JP-A-2002-287144 (Literature 1), for example.

On the other hand, a lighting device which irradiates light from both surfaces thereof (a two-side light-emitting type planar light-source device) is disclosed in Japanese Patent No. 3326854 (Literature 2), and one example of a light guide plate (a light guide body, a light guide) which is suitable for use in an optical system of a planar light-source device is disclosed in JP-A-2000-310777 (Literature 3).

### BRIEF SUMMARY OF THE INVENTION

In the both-surface liquid crystal display device described in the above-referenced literature 1, a main liquid crystal display panel and a sub liquid crystal display panel, which differ in the size of display screen thereof, share one planar light source in common. On the other hand, the mobile phone and the PDA are required to satisfy a demand for downsizing and a reduction of the power consumption, and, hence, as a both-surface liquid crystal display device which is mounted on a mobile phone or a PDA, a planar light source (a lighting device) such as the one described in literature 2, which combines light emitting diodes (semiconductor light emitting elements) and a light guide plate, is popularly used.

In such a lighting device (a two-side light-emitting-type planar light source), as described in literature 2, a main liquid crystal display panel is arranged to face one main surface of the light guide plate and a sub liquid crystal display panel is arranged to face the other main surface of the light guide plate; and, light which is incident on the light guide plate from a light source (the above-mentioned light emitting diodes), which is arranged to face one of the side surfaces of the light guide plate, is irradiated to respective main surfaces thereof, thus producing image displays on the main liquid crystal display panel and the sub liquid crystal display panel.

The light which is incident on the light guide plate from one side surface of the light guide plate is propagated in the inside of the light guide plate along the main surface, while the light which is reflected on one main surface is irradiated from the other main surface, the light which is reflected on the other main surface is irradiated from the one main surface, and this light is respectively incident on the sub liquid crystal display panel and the main liquid crystal display panel. To uniformly correct the irradiation intention of the lights from the respective main surfaces, which decrease corresponding to the distance from the light source (the side surface of the light guide plate which faces the light emitting diodes), a pattern formed of grooves and projections, as described in literature 3, is formed on at least one main surface of the light guide plate, and the size and the interval of the grooves and projections are changed corresponding to the distance from the light source.

However, compared to the area of the one main surface of the light guide plate which faces the main liquid crystal display panel in an opposed manner, the area of the other main surface of the light guide plate which faces the sub liquid crystal display panel is small, and the one main surface of the light guide plate faces the other main surface of the light guide plate in an opposed manner. Accordingly, the intensity of the light which is irradiated from the one main surface of the light guide plate, at one portion of the one main surface of the light guide plate which faces a region of the other main surface of the light guide plate which faces the sub liquid crystal display panel, is lowered compared to the intensity of light at a peripheral portion which surrounds this one portion. As a result, an image which is displayed on the main liquid crystal display panel suffers from so-called brightness irregularities in which the image becomes dark corresponding to regions of the main surface of the light guide plate which faces the other sub liquid crystal display panel.

The present invention provides, in a liquid crystal display device, which is referred to as a both-surface liquid crystal display device, a lighting device which is capable of displaying an image having a practically allowable uniform brightness over the whole region of a screen by suppressing the above-mentioned brightness irregularities that tend to be generated on a main liquid crystal display panel.

One mode of the above-mentioned liquid crystal display device (also referred to as a both-surface liquid crystal display device or a liquid crystal display module) which includes the above-mentioned lighting device provided by the present invention is as follows.

The liquid crystal display device includes a first liquid crystal display panel, a second liquid crystal display panel having a main surface that is smaller than the main surface of the first liquid crystal display panel, a light guide plate having a first main surface and a second main surface which face each other in an opposed manner and having a plurality of side surfaces , and a light source arranged to face one of the plurality of side surfaces of the light guide plate and including at least one light emitting element (for example, a light emitting diode or an optical guide member which is optically connected with the light emitting diode, provided separately from the light guide plate). The liquid crystal display device is assembled such that the first liquid crystal display panel is arranged to have the main surface thereof face the first main surface of the light guide plate and the second liquid crystal display panel is arranged to have the main surface thereof face a portion of the second main surface of the light guide plate, wherein an uneven-surface structure is provided to the second main surface of the light guide plate. The uneven-surface structure is provided for controlling the reflection of light which is propagated in the inside of the light guide plate on the second main surface. Further, at least one of the height and the depth of the uneven-surface structure with respect to the second main surface and the density and the area of the uneven-surface structure inside the second main surface may differ from each other between the above-mentioned one portion of the second main surface and a peripheral portion which is disposed close to the above-mentioned one portion.

Further, in these structures, at least one of the height, the depth, the density and the area of the uneven-surface structure on the second main surface of the light guide plate is increased corresponding to the distance from one side surface of the light source of the light guide plate, and at least one of the height, the depth, the density and the area of the uneven-surface structure on the above-mentioned one portion of the second main surface (portion where light is irradiated to the second liquid crystal display panel) is set to be larger than at least one of the height, the depth, the density and the area of the uneven-surface structure on a peripheral portion close to the above-mentioned one portion along one side surface (an extending direction of one side surface) of the light guide plate. When the light source is constituted of a plurality of light emitting elements which are juxtaposed while facing this one side surface in an opposed manner, the extending direction of the one side surface of the light guide plate may be referred to as the juxtaposing direction of the light emitting elements.

Further, the uneven-surface structure in the above-mentioned one portion of the second main surface is characterized by at least one of configurations in which the above-mentioned one portion is projected higher from the second main surface, is recessed deeper from the second main surface, is arranged to have a higher density (the shorter interval) in the inside of the second main surface, and is spread wider in the inside of the second main surface than a peripheral portion which is arranged close to the above-mentioned one portion.

Further, the uneven-surface structure on the second main surface of the light guide plate is constituted of a plurality of grooves formed in the second main surface.

Further, a casing (for example, a frame-like casing) is provided as part of the liquid crystal display device. A first recessed portion for holding the first liquid crystal display panel, the light guide plate and the light source is formed in a frame shape, for example, in one side of the casing and a second recessed portion for holding the second liquid crystal display panel is formed in a frame shape, for example, in another side of the casing which faces the one side of the casing in an opposed manner. Further, an opening which allows the light radiated from the second main surface of the light guide plate to irradiate the main surface of the second liquid crystal display panel is formed between the first recessed portion and the second recessed portion. The opening face is projected to the second main surface of the light guide plate, thus defining the above-mentioned one portion in the inside of the second main surface.

Further, with respect to the reflectance of one portion on the second main surface of the light guide plate and the reflectance of a peripheral portion close to one portion of the second main surface along one side surface of the light guide plate which faces the light source in an opposed manner, the reflectance of one portion is set to be higher than the reflectance of the peripheral portion in the light guide plate per se, and the difference between these reflectances is decreased by housing the light guide plate in the casing. That is, when the light guide plate is formed in a single body state and light is incident on the light guide plate from one side surface thereof, the deviation of the radiation intensity of light from the first surface, which is increased in the region of the first main surface which faces the one portion of the second main surface, is leveled by incorporating the light guide plate in the above-mentioned casing. As a result, in such a liquid crystal display device, the intensity of light radiated from the main surface of the light guide plate is not reduced at the region which faces the one portion of the second main surface, and, hence, brightness irregularities which are generated in the first liquid crystal display panel can be eliminated.

According to another mode of the present invention, a liquid crystal display device includes a first liquid crystal display panel, a second liquid crystal display panel having a main surface that is smaller than the main surface of the first liquid crystal display panel, a light guide plate having a first main surface, a second main surface which faces the first main surface and side surfaces, and a light source arranged at the side surface of the light guide plate. The first liquid crystal display panel is arranged to have the main surface thereof face the first main surface of the light guide plate, the second liquid crystal display panel is arranged to have a main surface thereof face a portion of the second main surface of the light guide plate, and grooves are formed in the second main surface of the light guide plate.

In this case, the grooves formed in the second main surface of the light guide plate may be configured such that the depths of the grooves are increased corresponding to an increase of the distance from the light source at least in a range from the light source to one portion of the second main surface. Further, the grooves formed in the second main surface of the light guide plate may be configured such that the groove which is remotest from the light source has a depth larger than the depth of the groove which is arranged closest to the light source. Further, the grooves formed in the second main surface of the light guide plate may be configured such that the depth of the groove among the grooves in one portion of the second main surface which is arranged at a side more remote from the light source is set to be larger than the depth of a neighboring groove in one portion of the second main surface.

According to still another mode of the present invention, a liquid crystal display device includes a first liquid crystal display panel, a second liquid crystal display panel having a main surface that is smaller than the main surface of the first liquid crystal display panel, a light guide plate having a first main surface, a second main surface and side surfaces, and a light source arranged to face a side surface of the light guide plate. The first liquid crystal display panel is arranged to have the main surface thereof face the first main surface of the light guide plate, the second liquid crystal display panel is arranged to have the main surface thereof face a portion of the second main surface of the light guide plate, and on the second main surface of the light guide plate, at least one of the height and the depth of an uneven-surface structure with respect to the second main surface and the density and the area of the uneven-surface structure in the second main surface differs between the above-mentioned one portion of the second main surface and a peripheral portion close to the above-mentioned one portion.

The present invention is not limited to the above-mentioned constitution and various modifications are conceivable without departing from the technical concept of the present invention.

### BRIEF DESCRIPTION OF THE DRAWINGS

FIGS. 1A and 1B are diagrams which show one example of a liquid crystal display device (a both-surface liquid crystal display device) according to the present invention, wherein FIG. 1A is a plan view of the liquid crystal display device as viewed from a main liquid crystal display panel mounting side, and FIG. 1B is a cross-sectional view of the liquid crystal display device taken along a line Ib-Ib′ in FIG. 1A.

FIGS. 2A to 2C are diagrams which show an example of a light guide plate suitable for the liquid crystal display device shown in FIG. 1A, wherein FIG. 2A is a plan view of the light guide plate as viewed from a main surface which faces the sub liquid crystal display panel, FIG. 2B is a cross-sectional view of the light guide plate taken along a line A-A′ and a line B-B′ shown in FIG. 2A, and FIG. 2C is a graph which shows a brightness profile of a main liquid crystal display panel of the liquid crystal display device in which the light guide plate is mounted as shown in FIG. 1B; and

FIGS. 3A and 3B are diagrams showing another example of the light guide plate which is preferably used in the liquid crystal display device shown in FIG. 1A, wherein FIG. 3A is a plan view of the light guide plate in which a plurality of grooves or projections are formed along a main surface of the light guide plate which faces the sub liquid crystal display panel in an opposed manner, and FIG. 3B is a plan view of the light guide plate in which a plurality of dots (recesses or projections) are formed on the main surface of the light guide plate which faces the sub liquid crystal display panel in an opposed manner.

### DESCRIPTION OF THE PREFERRED EMBODIMENTS

Preferred embodiments of a liquid crystal display device according to the present invention will be explained in detail in conjunction with the drawings. In all of the drawings, parts having identical functions are identified by the same symbols and a repeated explanation thereof will be omitted.

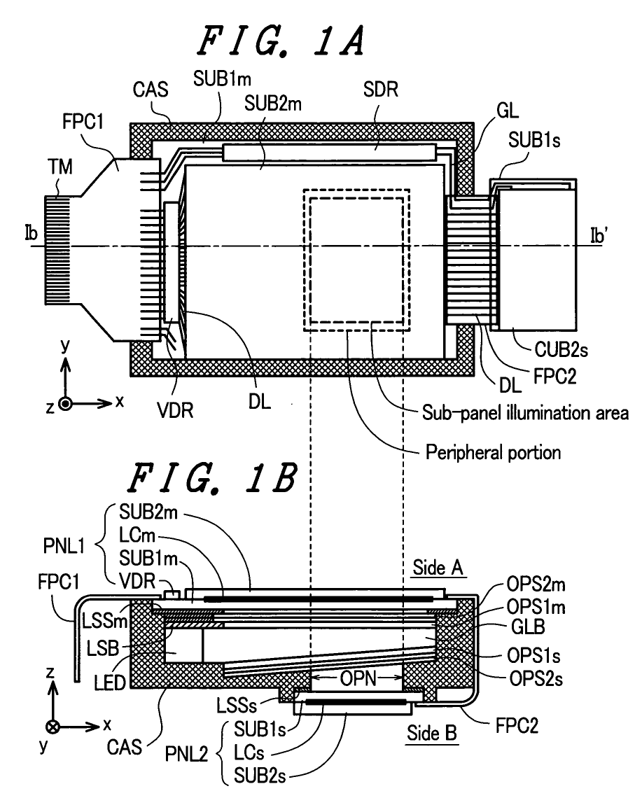

FIG. 1A shows the planar structure of one example of a liquid crystal display device (a both-surface liquid crystal display device) according to the present invention. This display device is provided with a main liquid crystal display panel PNL1 and a sub liquid crystal display panel PNL2, having a smaller screen than the main liquid crystal display panel PNL1, as depicted from a mounting surface of the main liquid crystal display panel PNL1. FIG. 1B shows the cross sectional structure of the liquid crystal display device taken along a line Ib-Ib′ in FIG. 1A. In the planar structure shown in FIG. 1A, for purposes of explanation of the manner of connection mode of the main liquid crystal display panel PNL1 and the sub liquid crystal display panel PNL2, the sub liquid crystal display panel PNL2 is depicted in a state in which the sub liquid crystal display panel PNL2 is not housed in a casing CAS. However, in a state in which the liquid crystal display device is completed, the sub liquid crystal display panel PNL2 is also housed in the casing CAS, as shown in FIG. 1B.

Here, the coordinate axes which are respectively indicated in FIG. 1A and FIG. 1B support an explanation of the shapes and the layouts of the liquid crystal display device of this embodiment and parts which are mounted on the liquid crystal display device, wherein, for example, the x axis indicates the direction away from a light source (a light emitting diode LED) or a side surface of a light guide plate GLB which faces the light source (a left-side end surface in FIG. 1B) along the light guide plate GLB, and the y axis indicates the direction of extension of the side surface of the light guide plate GLB, which faces the light source in an opposed manner.

Both the main liquid crystal display panel PNL1 and the sub liquid crystal display panel PNL2 shown in FIG. 1A and FIG. 1B have an active matrix type structure, in which an active element (a thin film transistor or the like) is arranged in each pixel. In the main liquid crystal display panel PNL1, a pair of substrates (glass substrates or plastic substrates) SUB1m, SUB2m having a suitable optical transmissivity are fixed to each other in a state such that the respective main surfaces of the pair of substrates SUB1m, SUB2m face each other; and, in a gap defined between these substrates, a liquid crystal layer LCm is provided, thus forming a display screen. In the same manner as the main liquid crystal display panel PNL1, a pair of substrates SUB1s, SUB2s having a suitable optical transmissivity are fixed to each other in a state such that respective main surfaces of the pair of substrates SUB1m, SUB2m face each other; and, in a gap defined between these substrates SUB1m, SUB2m, a liquid crystal layer LCs is provided, thus forming a display screen of the sub liquid crystal panel PL2.

As a casing CAS which holds the main liquid crystal display panel PNL1 and the sub liquid crystal display panel PNL2, a mold casing made of a resin material which is formed by molding, for example, is used. In the casing CAS, a first recessed portion which opens at one side (Side A shown in FIG. 1B), and a second recessed portion, which opens at another side (Side B shown in FIG. 1B) opposite to the first side, are formed.

The light emitting diode LED, a light source board LSB on which the light emitting diode LED is mounted and the light guide plate GLB are housed in the, first recessed portion, and the substrate SUB1m of the main liquid crystal display panel PNL1 is fitted in an inlet portion of the first recessed portion (an uppermost portion of the casing CAS shown in FIG. 1B). On the other hand, the substrate SUB1s of the sub liquid crystal display panel PNL2 is fitted in the second recessed portion (a lower surface of the casing CAS shown in FIG. 1B). At the inlet portion of the first recessed portion, a terraced surface, which is fitted on a periphery of the main liquid crystal display panel PNL1 (the substrate SUB1m), is formed in a frame shape, and the periphery of the main surface of the main liquid crystal display panel PNL1 is fixed to the terraced surface using a light shielding spacer LSSm having adhesiveness. Also, in the second recessed portion, a terraced surface which is fitted on the periphery of the sub liquid crystal display panel PNL2 (the substrate SUB1s) is formed in a frame shape, and the periphery of the main surface of the sub liquid crystal display panel PNL2 is fixed to the terraced surface using a light shielding spacer LSSs having adhesiveness.

Further, an opening OPN which reaches a bottom surface of the second recessed portion from a bottom surface of the first recessed portion is formed in the casing CAS, and light which is irradiated from a second main surface (a lower surface in FIG. 1B) of the light guide plate GLB through the opening OPN is irradiated to the main surface of the sub liquid crystal display panel PNL2 (substrate SUB1s). The area of the opening OPN is narrower than the bottom surface of the first recessed portion and the bottom surface of the second recessed portion.

On the other hand, between a first main surface of the light guide plate GLB and the main surface of the main liquid crystal display panel PNL1 (substrate SUB1m), an optical sheet (a light diffusion sheet) OPS1m, which uniformly diffuses light irradiated from the first main surface within the main surface of the substrate SUB1m, and an optical sheet (a focusing sheet) OPS2m, having a function of focusing the advancing direction of the light along a normal line of the main surface of the substrate SUB1m, are inserted. Further, between a second main surface of the light guide plate GLB and a main surface of the sub liquid crystal display panel PNL2 (substrate SUB1s), an optical sheet (a light diffusion sheet) OPS1s, which uniformly diffuses light irradiated from the second main surface (one portion facing the opening OPN) within the main surface of the substrate SUB1s, and an optical sheet (a focusing sheet) OPS2s, having a function of focusing the advancing direction of the light along a normal line of the main surface of the substrate SUB1s, are inserted. In the first recessed portion of the casing CAS, these optical sheets are stacked in the order of the focusing sheet OPS2s (two sheets), the light diffusion sheet OPS1s, the light guide plate GLB, the light diffusion sheet OPS1m and the focusing sheet OPS2m (two sheets) from the bottom surface. As the focusing sheets OPS2s, OPS2m, a prism sheet on which prism-like projections are formed on one main surface, for example, is used.

The focusing sheet OPS2s and the optical diffusion sheet OPS1s have an area which is substantially equal to or larger than the area of the screen of the main liquid crystal display panel PNL1; and, hence, the focusing sheet OPS2s and the optical diffusion sheet ops1s are arranged to bridge over the above-mentioned opening OPN at the bottom surface of the first recessed portion. Further, when the casing CAS is formed of a material which hardly allows the penetration of light therethrough, in a region of the focusing sheet ops2s which faces the bottom surface of the first recessed portion (not facing the opening OPN), the light radiated from the second main surface of the light guide plate GLB is made to return to the inside of the light guide plate GLB and is radiated to the main surface of the main liquid crystal display panel PNL1 from the first main surface. The optical characteristics of the optical diffusion sheet and the focusing sheet may be shared in common by the main liquid crystal display panel PNL1 and the sub liquid crystal display panel PNL2. Further, depending on the optical characteristics of the light guide plate GLB, either one or both of the light diffusion sheet and the focusing sheet need not be used.

Since both of the main liquid crystal display panel PNL1 and the sub liquid crystal display panel PNL2 of the embodiment shown in FIG. 1A have an active-matrix type structure, in each screen (each image display region), there are a plurality of video signal lines DL, which extend along the x axis and are juxtaposed along the y axis which intersects the x axis, and a plurality of scanning signal lines GL, which extend along the y axis and are juxtaposed along the x axis. In FIG. 1A, the illustration of the video signal lines DL and the scanning signal lines GL which are arranged in the respective screens of the main liquid crystal display panel PNL1 and the sub liquid crystal display panel PNL2 are omitted, and only portions of these lines which are arranged at the outside of the screens are illustrated.

On the periphery of the substrate SUB1m of the main liquid-crystal display panel PNL1 which is projected from the substrate SUB2m, a video signal drive circuit VDR and a scanning signal drive circuit SDR are mounted. The video signal drive circuit VDR outputs video signals to the plurality of video signal lines DL which are formed on the respective screens of the main liquid crystal display panel PNL1 and the sub liquid crystal display panel PNL2, while the scanning signal drive circuit SDR outputs scanning signals to the plurality of scanning signal lines GL which are formed on the respective screens of the main liquid crystal display panel PNL1 and the sub liquid crystal display panel PNL2. With respect to pixels which are formed on the respective screens of the main liquid crystal display panel PNL1 and the sub liquid crystal display panel PNL2, each pixel receives the video signal from one of the plurality of video signal lines DL through an active element formed on each pixel, and the timing thereof is controlled in response to the scanning signal inputted to the active element from one of the plurality of scanning signal lines GL.

On the screen of the main liquid crystal display panel PNL1 of this embodiment, the video signal lines which transmit the video signals for red, the video signals for green and the video signals for blue are repeatedly juxtaposed along the y axis in the order of red, green and blue, wherein the number of video signal lines for each color is 176. Accordingly, 528 video signal lines in total are juxtaposed in the screen of the main liquid crystal display panel PNL1. Further, 240 scanning signals lines, which intersect these video signal lines, are juxtaposed along the x axis, thus enabling the display of a color image, which is constituted of 42240 pixels in total.

On the other hand, on the screen of the sub liquid crystal display panel PNL2 of this embodiment, the video signal lines which transmit the video signals for red, the video signals for green and the video signals for blue are repeatedly juxtaposed along the y axis in the order of red, green and blue, wherein the number of video signal lines for each color is 120. Accordingly, 360 video signal lines in total are juxtaposed in the screen of the sub liquid crystal display panel PNL2. Further, 64 scanning signals lines, which intersect these video signal lines, are juxtaposed along the x axis, thus enabling the display of a color image, which is constituted of 7680 pixels in total.

On the other hand, the video signal drive circuit VDR outputs the video signals to 528 video signal lines (176 pieces for each color) formed on the main liquid crystal display panel PNL1 and 360 video signal lines (120 pieces for each color) formed on the sub liquid crystal display panel PNL2. For receiving the video data from an external circuit of the liquid crystal display device through a flexible printed circuit board FPC1, the video signal drive circuit VDR is mounted on the periphery (left end in FIG. 1A) of the main surface of the above-mentioned substrate SUB1m to which one end of the flexible printed circuit board FPC1 is connected. At the other end of the flexible printed circuit board FPC1, a plurality of terminals TM, which are connected to an external circuit (not shown in the drawing) of the liquid crystal display device, are provided. Outputting of the video signals from the video signal drive circuit VDR, which is arranged in the above-mentioned manner, to the video signal lines formed on the screen of the sub liquid crystal display panel PNL2 is performed through 360 signal lines (120 video signal lines for each color), of the video signal lines formed on the screen of the main liquid crystal display panel PNL1, and by extending these 360 video signal lines DL to the flexible printed circuit board FPC2 and the main surface of the substrate SUB1s of the sub liquid crystal display panel PNL2.

On the other hand, the scanning signal drive circuit SDR also sequentially outputs the scanning signals to 240 scanning signal lines formed on the screen of the main liquid crystal display panel PNL1 and 64 scanning signal lines formed on the screen of the sub liquid crystal display panel PNL2 in response to clock signals inputted to the scanning signal drive circuit SDR from an external circuit of the liquid crystal display device through the flexible printed circuit board FPC1. Outputting of the scanning signals from the scanning signal drive circuit SDR mounted on the periphery of the main surface of the substrate SUB1m (upper end in FIG. 1A) to the 64 scanning signal lines formed on the sub liquid crystal display panel PNL2 is performed by extending 64 scanning signal lines, which are pulled out to the periphery of the main surface of the substrate SUB1s of the sub liquid crystal display panel PNL2 (upper end in FIG. 1A) to the flexible printed circuit board FPC2 and the main surface of the substrate SUB1m of the main liquid crystal display panel PNL1.

The images (information) which are generated on the screen of the main liquid crystal display panel PNL1 and the screen of the sub liquid crystal display panel PNL2 for every frame period are recognized by a user by propagating the light from the light emitting diode (light emitting element) LED which is arranged to face one side surface of the light guide plate GLB in an opposed manner in the inside of the light guide plate GLB, by respectively radiating the light from the first main surface (the upper surface in FIG. 1B) and the second main surface (the lower surface in FIG. 1B and by irradiating the main liquid crystal display panel PNL1 and the sub liquid crystal display panel PNL2.

<Correction of Reflectance on the Main Surface of the Light Guide Plate GLB>

In the above-mentioned liquid crystal display device (both-surface liquid crystal display device), when used on a foldable mobile phone, for example, a keypad part thereof and the above-mentioned liquid crystal display panel PNL1 are mounted such that the keypad part and the main liquid crystal display panel PNL1 face each other in an opposed manner in a folded state. Accordingly, in a state in which the foldable mobile phone is folded (for example, at the time of waiting), only the image of the above-mentioned sub liquid crystal display panel PNL2 is visible by the user of the foldable mobile phone; while, in a state in which the foldable mobile phone is opened (for example, at the time of calling), the respective images of the main liquid crystal display panel PNL1 and the sub liquid crystal display panel PNL2 are visible by the user of the foldable mobile phone.

In a so-called edge-light type liquid crystal display device having a light guide plate and a light source which is arranged at a side surface of the light guide plate, even when a reflection structure is provided to one of the main surfaces of the light guide plate so as to return light radiated from the light guide plate to the inside of the light guide plate, radiation of light from the one main surface of the light guide plate is generated. Accordingly, even when such reflection structure is provided to the second main surface of the light guide plate GLB, which is mounted on the liquid crystal display device of this embodiment, light having a sufficient intensity is radiated from the reflection structure to the sub liquid crystal display panel PNL2. Accordingly, the sub liquid crystal display panel PNL2 of the foldable mobile phone on which the liquid crystal display device of this embodiment is mounted receives sufficient light irradiation even in a state in which the foldable mobile phone is folded and opened; and, hence, the image formed on the sub liquid crystal display panel PNL2 can be recognized by the user of the foldable mobile phone.

On the other hand, the main liquid crystal display panel PNL1, which is mounted on the foldable mobile phone, is irradiated by light which is radiated from the first main surface of the light guide plate GLB. However, the first main surface has a portion thereof which faces the second main surface of the light guide plate GLB, which faces the sub liquid crystal display panel PNL2, and the main liquid crystal display panel PNL1 provides an image to the user in a state in which the foldable mobile phone is opened; and, hence, brightness irregularities arise on the images displayed on the main liquid crystal display panel PNL1.

The causes of the brightness irregularities generated on the screen of the main liquid crystal display panel PNL1 will be explained as follows. When the images are generated on both of the main liquid crystal display panel PNL1 and the sub liquid crystal display panel PNL2 for every frame period, as described above, a region which allows light to pass therethrough is formed at least at a portion of the screen of the sub liquid crystal display panel PNL2. Further, even when image display on the sub liquid crystal display panel PNL2 is stopped during the image display period of the main liquid crystal display panel PNL1, when the liquid crystal display device is driven in a normally white mode in which the sub liquid crystal display panel PNL2 exhibits the maximum optical transmissivity when an electric field applied to a liquid crystal layer LCs is minimum, the whole screen of the sub liquid crystal display panel PNL2 favorably allows the transmission of light. Accordingly, even when the above-mentioned reflection structure is provided to the second main surface of the light guide plate GLB, a portion of the light to be reflected toward the first main surface is emitted to the outside of the foldable mobile telephone (in an opened state) through the opening OPN formed in the casing CAS and the screen of the sub liquid crystal display panel PNL2.

On the contrary, portions of the second main surface of the light guide plate GLB, except for one portion which faces the sub liquid crystal display panel PNL2, face an inner wall of the casing CAS; and, hence, the light which is radiated from the portions of the second main surface is efficiently reflected toward the first main surface due to the above-mentioned reflection structure. Accordingly, on the screen of the main liquid crystal display panel PNL1, there arises a dark portion which corresponds to one portion of the second surface of the light guide plate GLB which faces the sub liquid crystal display panel PNL2. For example, on the screen (substantially corresponding to the main surface of the substrate SUB2m) of the main liquid crystal display panel PNL1 shown in FIG. 1A, in the inside of a broken line frame which is designated as the sub panel illumination region, the brightness of the display image becomes lower than the brightness of the image in other regions which surround that region. The sub panel illumination region is defined by projecting the region (the above-mentioned “one portion”) where the second main surface of the light guide plate GLB faces the sub liquid crystal display panel PNL2 to the first main surface of the light guide plate GLB. Further, when the main liquid crystal display panel PNL1 is mounted on one surface (Side A) of the casing CAS having the opening OPN, as shown in FIG. 1B, and the sub liquid crystal display panel PNL2 which constitutes the second main surface is mounted on another surface (Side B) of the casing CAS, the sub panel illumination region may be also defined by projecting “one portion” of the second main surface of the light guide plate GLB which faces the opening OPN to the first main surface of the light guide plate GLB.

Assume that the casing CAS is made of a material having a high optical transmissivity so as to narrow the difference between the brightness of the sub panel illumination region and the brightness of the regions other than the sub panel illumination region on the screen (substrate SUB2m) of the main liquid crystal display panel PNL1. Even under such an assumption, so long as the housing (at least the image display part) of the foldable mobile phone in which this liquid crystal display device is incorporated is formed of a material which hardly allows the transmission of light, the above-mentioned brightness irregularities are not solved.

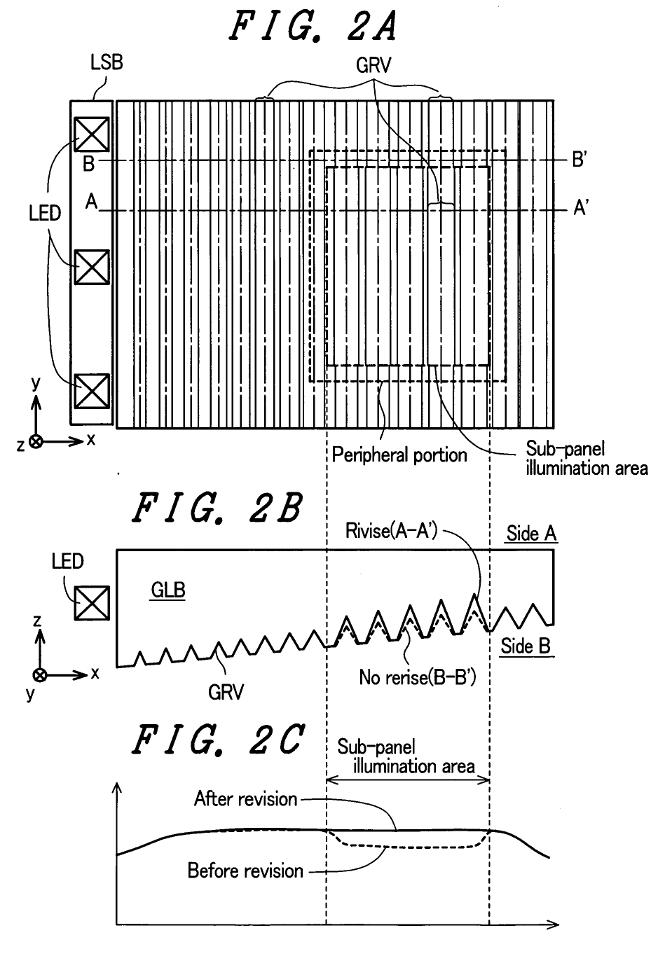

Under such circumstances, the present invention provides for use of the light guide plate GLB shown in FIGS. 2A to 2C in the liquid crystal display device (both-surface liquid crystal module) shown in FIG. 1A. In FIG. 2A, the planar structure of one example of the light guide plate GLB according to the present invention, as viewed from the second main surface, is depicted together with the three light emitting elements LED, which are arranged to face one side surface of the light guide plate GLB, and a light source board LSB on which these light emitting elements LED are mounted. Accordingly, the plan view shown in FIG. 2A is depicted such that the second main surface of the light guide plate GLB and the light emitting elements LED face up from the bottom surface of the first recessed portion of the casing CAS shown in FIG. 1B. A linear region which is bounded by a pair of solid lines indicated in the second main surface of the light guide plate GLB indicates a plurality of grooves GRV formed in the second main surface, and a chain line which is indicated as the center of the linear region indicates a “valley” or root of each groove GRV with respect to the second main surface. By gradually increasing a width of the grooves GRV as the distance from one side surface of the light guide plate GLB which faces the three light emitting elements LED is increased along the x axis, it is possible to make the light which is propagated in the light guide plate GLB strongly reflect toward the first main surface. By increasing the width of the grooves corresponding to the increase of the distance from one side surface of the light guide plate GLB which faces the light source (light emitting elements LED), it is possible to compensate for the radiation intensity of the light from the first main surface of the light guide plate GLB which is attenuated corresponding to the distance from one side surface of the light guide plate GLB. Here, the attenuation of the light radiated from the first main surface of the light guide plate GLB is generated even when the reflection structure is not provided on the second main surface of the light guide plate GLB.

In the planar structure of the light guide plate GLB shown in FIG. 2A, the feature of the present invention is demonstrated by the difference in the width of the groove GRV between a “sub panel irradiation region” which is bounded by a broken line (corresponding to the above-mentioned “one portion” on the second main surface of the light guide plate GLB which faces the sub liquid crystal display panel PNL2) and a region which is sandwiched by the broken line and a dotted line which surrounds the broken line (hereinafter, referred to as a “peripheral portion” ). In the region (including the above-mentioned “peripheral portion”) other than the “sub panel irradiation region” on the second main surface of the light guide plate GLB, the width of each groove GRV is gradually increased corresponding to an increase of the distance from the light source side of the light guide plate GLB (left end in FIG. 2A). On the other hand, in the “sub panel irradiation region”, the width of the groove GRV is sharply increased and some grooves have a width that is larger than the width of the grooves GRV which are more remote from the light source than the grooves in the “sub panel irradiation region”. Such a difference in the reflection structure between the “sub panel irradiation region” and the other regions on the second main surface of the light guide plate GLB cam be characterized by comparing the “sub panel irradiation region” and the above-mentioned “peripheral portion” which is arranged close to the “sub panel irradiation region” along the direction of extension of the side surface of the light guide plate GLB which faces the light source. In the planar structure of the light guide plate GLB shown in FIG. 2A, an area (a width) of the uneven-surface structure (grooves) which controls the reflection of the light which is propagated in the inside of the light guide plate GLB by the second main surface differs between the “sub panel irradiation region” and the “peripheral portion” which is arranged close to the “sub panel irradiation region”, wherein the area of the uneven-surface structure in the former is larger than the area of the uneven-surface structure in the latter.

A plurality of grooves formed on the second main surface of the light guide plate GLB shown in FIG. 2A, as indicated by the cross-sectional structure of the light guide plate GLB depicted in FIG. 2B, also differ with respect to the change of depth thereof corresponding to the distance from the light source between the above-mentioned “sub panel irradiation region” and other regions. FIG. 2B shows the light guide plate GLB and the light source which faces one of a plurality of side surfaces of the light guide plate GLB, in which the first main surface and the second main surface are spaced apart from each other (however, only the light emitting element LED is shown) by extracting these parts from FIG. 1B. The grooves GRV which are formed on the second main surface (lower surface in FIG. 2B) of the light guide plate GLB are formed such that the depths thereof are increased corresponding to an increase of the distance from one side surface of the light guide plate GLB which faces the light source. Such a change of the depths of the juxtaposed grooves GRV in the x-axis direction is indicated by replacing the grooves indicated by a solid line in the “sub panel irradiation region” in FIG. 2B with the grooves indicated by a dotted line (a cross-sectional shape along a line B-B′ indicated by “reflectance not corrected” in FIG. 2A). In this manner, by increasing the depths of the grooves GRV corresponding to the increase of the distance from the light source, it is possible to compensate for the radiation strength of light from the first main surface of the light guide plate GLB which is attenuated corresponding to the increase of the distance from the light source. When the cross-sectional shape of the plurality of grooves GRV juxtaposed along the line A-A′ including the “sub panel irradiation region” is set substantially equal to the cross-sectional shape of the grooves GRV along the line B-B′, the strength of light irradiated from the first main surface of the light guide plate GLB (the brightness of the main liquid crystal display panel PNL1 when the whole screen is displayed in white) locally falls at the “sub panel irradiation region” (one portion of the second main surface which faces the sub liquid crystal display panel PNL2) as indicated by the broken line in FIG. 2C.

Such a local reduction of the brightness of the first main surface induces brightness irregularities in the screen of the above-mentioned main liquid crystal display panel PNL1. Here, in FIG. 2C, the brightness (Side A) of the main liquid crystal display panel PNL1 is taken on an axis of abscissas and the distance from the light source is taken on an axis of ordinates.

On the contrary, when the cross section of the grooves GRV in the “sub panel irradiation region” is changed into the shape depicted by the solid line, which is indicated by “reflectance corrected”, in FIG. 2B, the reduction of the brightness in the vicinity of the center of the first main surface of the light guide plate GLB (screen of the main liquid crystal display panel PNL1) indicated by a broken line in FIG. 2C is eliminated, as shown by a solid line, which is indicated as “after reflectance corrected”; and, hence, the brightness irregularities on the screen of the main liquid crystal display panel PNL1 are hardly recognized by the user of the mobile phone on which the liquid crystal display device of this embodiment in mounted.

As can be clearly understood from the comparison of the cross-sectional shape (taken along the above-mentioned A-A′ line) of the grooves GRV indicated by the solid line in the “sub panel irradiation region” and the cross-sectional shape (taken along the above-mentioned B-B′ line) of the grooves GRV indicated by the dotted line in FIG. 2B, the depth of the grooves GRV, which is gradually increased corresponding to an increase of the distance from the light source, are sharply increased in the “sub panel irradiation region”, as indicated by the solid line. On the contrary, the depths of the grooves GRV formed in the “peripheral portion” arranged close to the “sub panel irradiation region” along the extending direction (the y axis in FIG. 2A) of the side surface, which faces the light source of the light guide plate GLB, are still gradually increased corresponding to the increase of the distance from the light source as indicated by the dotted line. Accordingly, among the grooves GRV formed in the “sub panel irradiation region”, the grooves GRV which have larger depths than the grooves which are more remote from the light source than “sub panel irradiation region” are included.

To compare the reflection structure of the “sub panel irradiation region” and the reflection structure of the “peripheral portion” which is arranged close to the “sub panel irradiation region” on the second main surface of the light guide plate GLB, which has been described in conjunction with FIG. 2B along with the extending direction of the side surface of the light guide plate GLB which faces the light source, the difference is as follows. In the cross-sectional structure of the light guide plate GLB shown in FIG. 2B, the depth of the uneven-surface structure (grooves) which controls the reflection of the light propagated in the inside of the light guide plate GLB by the second main surface with respect to the inside of the second main surface differs between the “sub panel irradiation region” and the “peripheral portion” which is arranged close to the “sub panel irradiation region” from each other, wherein the peak-to-valley of the former uneven-surface structure is larger than the peak-to-valley of the latter uneven-surface structure.

FIG. 2C, which shows the advantageous effect of the light guide plate GLB of the present invention, which is used as the reference in the above-mentioned explanation, shows the result of the measurement which is obtained in a state in which the light guide plate GLB is mounted in the casing CAS together with both the main liquid crystal display panel PNL1 and the sub liquid crystal display panel PNL2, as shown in FIG. 1B. In this experiment, the whole regions of the respective screens of the main liquid crystal display panel PNL1 and the sub liquid crystal display panel PNL2 are displayed in white (by maximizing the optical transmissivities of the respective screens) and the intensity of light which is emitted from the screen of the main liquid crystal display panel PNL1 (the upper surface of the substrate SUB2m shown in FIG. 1B) is measured. Based on the measured result of the intensity of light (the brightness of the main liquid crystal display panel PNL1), the distribution of the radiation intensity of light on the first main surface of the light guide plate GLB will be discussed.

However, when the light source is arranged at one of the side surfaces of the light guide plate GLB in a naked state as shown in FIG. 2A and FIG. 2B without mounting the light guide plate GLB of the present invention in the casing CAS as described above, the distribution (the change along the direction of the x axis) of the radiation intensity of light on the first main surface differs from the distribution of the radiation intensity of light shown in FIG. 2C. To measure the intensity of light radiated from the first main surface of the light guide plate GLB in a single product state, the light intensity before the correction of the reflectance indicated by the broken line in FIG. 2C is not reduced in the “sub panel irradiation region” and the light intensity after the correction of the reflectance, which is indicated by the solid line, is locally elevated in the “sub panel irradiation region”. Accordingly, the brightness of the light guide plate GLB per se on the first main surface is locally elevated in the “sub panel irradiation region” (one portion of the first main surface which faces one portion of the second main surface) which is formed by correcting the reflection structure of the second main surface at one portion which faces the sub liquid crystal display panel PNL2. This local elevation of the brightness of the light guide plate GLB per se on the first main surface suppresses the excessive leaking of light from one portion of the second main surface to the sub liquid crystal display panel PNL2, which occurs when the light guide plate GLB is mounted in the casing CAS. Due to such a constitution, in the liquid crystal display device of the present invention, which is assembled such that the main liquid crystal display panel PNL1 is arranged on the first main surface of the light guide plate GLB and the sub liquid crystal display panel PNL2 is arranged on the second main surface of the light guide plate GLB, it is possible to suppress the occurrence of brightness irregularities on the screen of the main liquid crystal display panel PNL1, and, at the same time, it is possible to produce a display on the screen of the sub liquid crystal display panel PNL2 with a practically usable brightness.

With respect to the light guide plate GLB of the above-mentioned embodiment, the width (area) and the depth of the groove formed in the second main surface differ between the ““sub panel irradiation region” (one portion which faces the second panel PNL2) and the other portions. However, even when either one of the width and the depth of the groove is made different between the “sub panel irradiation region” and the other portions, it is possible to obtain advantageous the effect shown in FIG. 2C. Further, it is also possible to obtain the substantially same advantageous effect by wholly replacing the plurality of grooves (recessed portions) formed in the second main surface with a plurality of projections (convex portions) which project from the second main surface. In the light guide plate GLB having the second main surface on which the plurality of ridge-like projections are juxtaposed from the light source side, the height of the uneven-surface structure (projections) which controls the reflection of light, which is propagated in the inside of the light guide plate GLB caused by the second main surface with respect to the second main surface, differs between the “sub panel irradiation region” and the “peripheral portion” arranged close to the “sub panel irradiation region”, wherein the peak-to-valley of the former uneven-surface structure is larger than the peak-to-valley of the latter uneven-surface structure.

<<Another Embodiment for Effecting Reflectance Correction on the Main Surface of the Light Guide Plate GLB>>

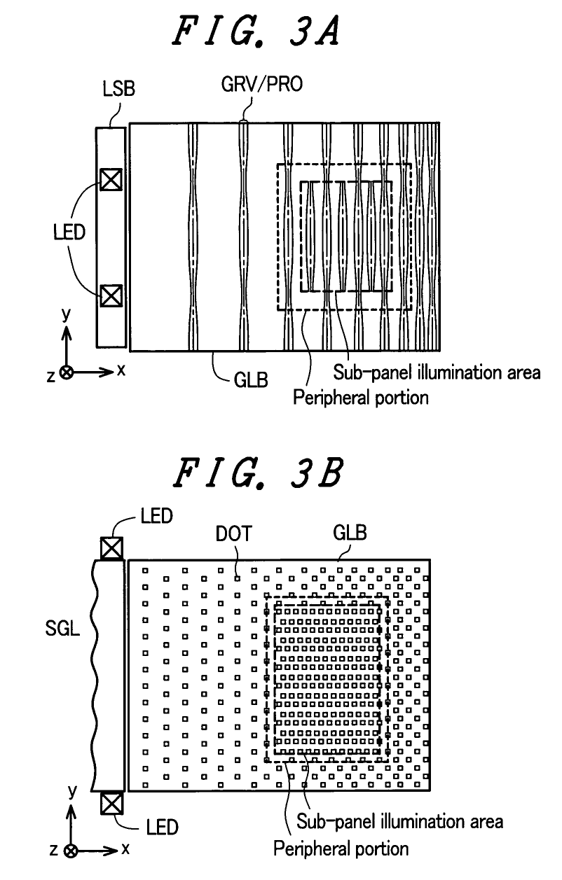

The light guide plate suitable for a so-called both-surface liquid crystal display device according to the present invention is not limited to the above-mentioned structure, which has been explained in conjunction with FIG. 2A and FIG. 2B, and it may be embodied as the planar structure shown in FIG. 3A and FIG. 3B. In both of FIG. 3A and FIG. 3B, in the same manner as FIG. 2A, the planar structure of the light guide plate GLB, as viewed from the second main surface, is depicted together with the light sources (the details thereof individually differing from each other) which are arranged to face one side surface thereof in an opposed manner.

On the second main surface of the light guide plate GLB shown in FIG. 3A, a plurality of grooves GRV or projections PRO, each of which is formed of a pair of curved lines, are sequentially juxtaposed from the light source side of the light guide plate GLB along the x-axis direction. A chain line which is sandwiched by the pair of curved lines indicates a valley or root portion when the pair of curved lines indicate a groove GRV, and it indicates a ridge (a peak) when the pair of curved lines indicate a projection PRO. In the embodiment shown in FIG. 3A, the light source which includes two light emitting elements LED juxtaposed along one side surface of the light guide plate GLB. Accordingly, to reduce the deviation of the light attributed to the fact that the light emitting elements LED constitute spot lights, the width of the groove GRV or the projection PRO, which is indicated by the distance between the pair of curved lines, is narrowed at positions where the groove GRV or the projection PRO face the light emitting elements LED in an opposed manner, while the depth of the grooves GRV or the height of the projections PRO are also suppressed at positions where the groove GRV or the projection PRO faces the light emitting elements LED in an opposed manner.

The widths of the plurality of grooves GRV formed on the second main surface of the light guide plate GLB shown in FIG. 3A are changed in the same manner along the y-axis direction irrespective of the positions (distances from the light source side) where the respective grooves GRV are formed. Even when the plurality of grooves GRV are replaced with the plurality of projections PRO, the widths of the respective projections PRO are also changed in the same manner along the y-axis direction irrespective of the positions where the respective projections PRO are formed. Further, the depths of the respective grooves GRV are changed along the y-axis direction in the same manner, while the heights of the respective projections PRO are changed along the y-axis direction in the same manner. In both of a case in which the plurality of grooves GRV are juxtaposed on the second main surface of the light guide plate GLB and a case in which the plurality of projections PRO are juxtaposed on the second main surface of the light guide plate GLB, the interval between the grooves GRV or between the projections PRO is sequentially narrowed corresponding to the increase of the distance from the light source side. In this manner, by sequentially narrowing the interval between the grooves GRV or the projections PRO on the second main surface of the light guide plate GLB, it is possible to compensate for the radiation intensity of light from the first main surface of the light guide plate GLB, which is attenuated corresponding to the increase of the distance from the one side surface of the light guide plate GLB which faces the light source.

However, as shown in FIG. 3A, on the “sub panel irradiation region” on the second main surface of the light guide plate GLB, a new groove GRV is formed in a gap of the grooves GRV formed in the “peripheral portion” arranged close to the “sub panel irradiation region” or a new projection PRO is formed in a gap of the projections PRO formed in the “peripheral portion”. Accordingly, the distance between the grooves GRV or the projections PRO along the x-axis direction is narrowed more at the “sub panel irradiation region” than at the “peripheral portion” arranged close to the “sub panel irradiation region”. Further, in the “sub panel irradiation region”, there exist portions where the grooves GRV or the projections PRO are arranged with an interval that is narrower than the interval between the grooves GRV or the projections PRO that are formed more remote from the light source than the “sub panel irradiation region”. In this manner, also by narrowing the interval between the grooves GRV or the projections PRO formed in one portion on the second main surface of the light guide plate GLB which faces the sub liquid crystal display panel (“sub panel irradiation region”) more than the interval between the grooves GRV or the projections PRO formed in the “peripheral portion” arranged close to the “sub panel irradiation region”, the brightness irregularities on the screen of the main liquid crystal display panel PNL1 can be suppressed, as explained in conjunction with FIG. 2C.

When comparing the reflection structure of the “sub panel irradiation region” and the reflection structure of the “peripheral portion” which is arranged close to the “sub panel irradiation region” on the second main surface of the light guide plate GLB, which has been described in conjunction with FIG. 3A along with the extending direction (y axis) of the side surface of the light guide plate GLB which faces the light source, the difference is as follows. The density (density along the x axis, interval) of the uneven-surface structure (grooves GRV or projections PRO) which controls the reflection of the light propagated in the inside of the light guide plate GLB by the second main surface in the inside of the second main surface differs between the “sub panel irradiation region” and the “peripheral portion” which is arranged close to the “sub panel irradiation region”, wherein the density of the former uneven-surface structure is larger than the density of the latter uneven-surface structure.

On the other hand, on the second main surface of the light guide plate GLB shown in FIG. 3B, a plurality of dots DOT indicated by small squares are formed and the density of the dots (the number of dots with respect to a unit area of the second main surface) is gradually increased corresponding to an increase of the distance from one side surface of the light guide plate GLB which faces the light source in an opposed manner. In this manner, by sequentially increasing the density of the plurality of dots DOT formed on the second main surface of the light guide plate GLB corresponding to the increase of the distance from the light source, it is possible to compensate for the radiation intensity of light from the first main surface of the light guide plate GLB which is attenuated along with the increase of the distance from one side surface of the light guide plate GLB which faces the light source. On the second main surface of the light guide plate GLB shown in FIG. 3B, a quadrangular pyramidal indentation (recessed portion) or a quadrangular pyramidal projection (pyramidal convex portion) is formed for every square which indicates each dot. Further, the quadrangular pyramids of respective dots DOT formed as indentations or projections on the second main surface have an equal depth or an equal height and an equal bottom area irrespective of the positions of the dots DOT in the inside of the second main surface.

The shape of the indentations or the projections which are formed on the second main surface of the light guide plate GLB as the dots is not limited to the above-mentioned quadrangular pyramid and may be replaced with a polygonal pyramid such as a trigonal pyramid, an octagonal pyramid, or the like, a cone, or a truncated pyramid or a truncated cone, which is formed by cutting off the head of the polygonal pyramid or cone. The plurality of dots DOT formed on the second main surface of the light guide plate GLB as the plurality of indentations or the plurality of projections provide an uneven-surface structure on the second main surface and control the reflection of the light propagated in the light guide plate GLB by the second main surface irrespective of the individual shapes of the dots.

The light source which faces one end of the light guide plate GLB shown at the left end of FIG. 3B in an opposed manner includes an auxiliary light guide plate SGL and two light emitting elements LED which are arranged at both ends of the auxiliary light guide plate SGL. The auxiliary light guide plate SGL is formed by molding using a light transmitting material, such as an acrylic resin, in the same manner as the light guide plate GLB, and it has a light emission surface which faces one side surface of the light guide plate GLB in an opposed manner and a reflection surface which faces the light emission surface in an opposed manner. The light emission surface and the reflection surface extend in the y-axis direction and the corrugated uneven structure is formed on the reflection surface along the y axis. The light emission surface and the light reflection surface are coupled to light incident surfaces at both ends thereof and the respective light incident surfaces are optically connected with the light emitting elements LED. Light which is incident on the auxiliary light guide plate SGL through both light incident surfaces advances along the y axis in the inside of the auxiliary light guide plate SGL while being gradually reflected toward the light emission surface side by the corrugated reflection surface. Accordingly, the light source shown in FIG. 3B, while using the spot lights which are constituted of the light emitting elements LED, can radiate light with a substantially uniform intensity from the light emission surface of the auxiliary light guide plate SGL and functions as a so-called flat-plane light source, which irradiates one side surface of the light guide plate GLB.

As shown in FIG. 3B, the density of the dots DOT formed on the second main surface of the light guide plate GLB (the number of dots per a unit area) is set to be larger at the “sub panel irradiation region” than at the “peripheral region” arranged close to the “sub panel irradiation region”. The density of the dots DOT in the “sub panel irradiation region” is set to be larger than the density of the dots DOT at the peripheral portion more remote from the light source than the “sub panel irradiation region” (the peripheral portion arranged at the right side of the “sub panel irradiation region” shown in FIG. 3B). Accordingly, the brightness of the first main surface of the light guide plate GLB shown in FIG. 3B is increased locally in the “sub panel irradiation region” in a single-body state.

However, by mounting the light guide plate GLB in the casing CAS together with the main liquid crystal display panel PNL1 and the sub liquid crystal display panel PNL2, as shown in FIG. 1B, it is possible to suppress a reduction of the in-plane local brightness in the inside of the screen of the main liquid crystal display panel PNL1 as shown in FIG. 2C, and, hence, the occurrence of brightness irregularities on the screen of the main liquid crystal display panel PL1 can be suppressed.

When the reflection structure of the “sub panel irradiation region” is compared to the reflection structure of the “peripheral portion” which is arranged close to the “sub panel irradiation region” on the second main surface of the light guide plate GLB, which has been described in conjunction with FIG. 3B along with the extending direction (y axis) of the side surface of the light guide plate GLB which faces the light source, the difference is as follows. The density (the number of dots per unit area) of the uneven-surface structure (dots DOT) which controls the reflection of the light propagated in the inside of the light guide plate GLB by the second main surface in the inside of the second main surface differs between the “sub panel irradiation region” and the “peripheral portion” which is arranged close to the “sub panel irradiation region”, wherein the density of the former uneven-surface structure is larger than the density of the latter uneven-surface structure.

With respect to the light guide plate GLB, on which a plurality of dots DOT are formed on the second main surface, in place of the structure shown in FIG. 3B in which the density of the dots DOT formed in the “sub panel irradiation region” is set to be higher than the density of the dots DOT formed in the regions arranged close to both sides of the “sub panel irradiation region” along the y axis, it may be possible to adopt the following structure. In a modified structure, the dots DOT are formed on both of the “sub panel irradiation region” and the regions arranged close to both sides of the “sub panel irradiation region” and along the y axis with the same density, while the size of the dots DOT formed in the “sub panel irradiation region” is set to be larger than the size of the dots DOT formed on the neighboring regions thereof. When the dots DOT are constituted of indentations formed in the second main surface, at least either one of the bottom area or the depth of the dots DOT formed in the “sub panel irradiation region” is set to be larger than the bottom area or the depth of the dots DOT formed in the neighboring regions. When the dots DOT are constituted of protrusions formed on the second main surface, at least either one of the bottom area or the height of the dots DOT formed in the “sub panel irradiation region” is set to be larger than the bottom area or the height of the dots DOT formed in the neighboring regions.

In this manner, the dots DOT in the “sub panel irradiation region” on the second main surface of the light guide plate GLB are formed with a density which is equal to the density of the dots DOT in other regions, while the size of the dots DOT in the “sub panel irradiation region” is set to be larger than the size of the dots DOT in other regions. Accordingly, at least one of the height or the depth of the uneven-surface structure (dots DOT) which controls the light propagated in the inside of the light guide plate GLB by the second main surface and the area of the uneven-surface structure in the second main surface differs between the “sub panel irradiation region” and the “peripheral portion” which is arranged close to the “sub panel irradiation region”. In one example, the area of the uneven-surface structure in the second main surface at the “sub panel irradiation region” is set to be larger than the area of the uneven-surface structure in the “peripheral portion”, and, hence, the reflectance of the second main surface in the “sub panel irradiation region” is corrected in the same manner as the light guide plate GLB shown in FIG. 2A.

Further, in one example in which the dots DOT are constituted of indentations formed in the second main surface, the uneven-surface structure in the “sub panel irradiation region” is formed so as to be deeper than the uneven-surface structure in the “peripheral portion”. Still further, in one example in which the dots DOT are constituted of projections formed on the second main surface, the uneven-surface structure in the “sub panel irradiation region” is formed so as to be higher than the uneven-surface structure in the “peripheral portion”. In both of these two examples, the peak-to-valley of the uneven-surface structure in the “sub panel irradiation region” becomes larger than the peak-to-valley of the uneven-surface structure in the “peripheral portion”, and, hence, it is possible to correct the reflectance of the second main surface in the “sub panel irradiation region” in the same manner as the light guide plate GLB shown in FIG. 2B.

According to the present invention, in a liquid crystal display device (a both-surface liquid crystal display device) in which the first liquid crystal display panel (the main liquid crystal display panel) is irradiated at one main surface of the light guide plate having a light source at one end thereof and in which the second liquid crystal display panel (the sub liquid crystal display panel) having the smaller screen than the first liquid crystal display panel is irradiated at another main surface of the light guide plate, it is possible to compensate for local lowering of the light radiation intensity at one main surface of the light guide plate which occurs corresponding to one portion of the main surface of the light guide plate which faces the second liquid crystal display panel in an opposed manner, whereby brightness irregularities which tend to occur on the screen of the first liquid crystal display panel can be suppressed. Accordingly, the display quality of the respective screens of the first liquid crystal display panel and the second liquid crystal display panel can be enhanced. Further, in a foldable mobile phone or a personal digital assistant in which the liquid crystal display device is mounted, the visibility of the image (information) displayed on the main screen and the sub screen can be enhanced.

1. A liquid crystal display device comprising:
a first liquid crystal display panel having a main surface;
a second liquid crystal display panel having a main surface that is smaller than the main surface of the first liquid crystal display panel;
a light guide plate having a first main surface, a second main surface which faces the first main surface in an opposed manner and a plurality of side surfaces; and
a light source arranged to face one of the plurality of side surfaces of the light guide plate and including at least one light emitting element, wherein
the liquid crystal display device is assembled such that the first liquid crystal display panel is arranged to have the main surface thereof face the first main surface of the light guide plate,
the second liquid crystal display panel is arranged to have the main surface thereof face a portion of the second main surface of the light guide plate, and
an uneven-surface structure is provided to the second main surface of the light guide plate.

2. A liquid crystal display device according to claim 1, wherein the uneven-surface structure operates to control the reflection of light which is propagated in the inside of the light guide plate on the second main surface.

3. A liquid crystal display device according to claim 1, wherein at least one of the height and the depth of the uneven-surface structure with respect to the second main surface and the density and the area of the uneven-surface structure inside the second main surface of the light guide plate differs between one portion of the second main surface and a peripheral portion which is disposed close to said one portion in the light guide plate.

4. A liquid crystal display device according to claim 1, wherein, in the uneven-surface structure, at least one of the height or the depth with respect to the second main surface of the light guide plate, the density and the area in the second main surface of the light guide plate is increased corresponding to an increase of the distance from one side surface of the light source of the light guide plate, and at least one of the height, the depth, the density and the area of the uneven-surface structure on one portion of the second main surface of the light guide plate is set larger than at least one of the height, the depth, the density and the area of the uneven-surface structure on a peripheral portion close to one portion along one side surface of the light guide plate.

5. A liquid crystal display device according to claim 1, wherein the uneven-surface structure is constituted of a plurality of grooves formed in the second main surface of the light guide plate.

6. A liquid crystal display device according to claim 1, wherein the liquid crystal display device further includes a casing in which a first recessed portion for holding the first liquid crystal display panel, the light guide plate and the light source is formed in one side of the casing, and a second recessed portion for holding the second liquid crystal display panel is formed in another side of the casing which faces one side surface of the casing, an opening which allows the light radiated from the second main surface of the light guide plate to irradiate the main surface of the second liquid crystal display panel is formed between the first recessed portion and the second recessed portion, and one portion on the second main surface of the light guide plate is defined as a portion which faces the opening of the second main surface.

7. A liquid crystal display device according to claim 6, wherein with respect to the reflectance of one portion on the second main surface of the light guide plate and the reflectance of a peripheral portion close to said one portion along one side surface of the light guide plate which faces the light source in an opposed manner, the reflectance of said one portion is higher than the reflectance of the peripheral portion in the light guide plate, and the difference between reflectances is decreased by housing the light guide plate in the casing.

8. A liquid crystal display device comprising:
a first liquid crystal display panel having a main surface;
a second liquid crystal display panel having a main surface that is smaller than the main surface of the first liquid crystal display panel;
a light guide plate having a first main surface, a second main surface which faces the first main surface in an opposed manner and side surfaces; and
a light source arranged to face a side surface of the light guide plate, wherein
the first liquid crystal display panel is arranged to have the main surface thereof face the first main surface of the light guide plate,
the second liquid crystal display panel is arranged to have the main surface thereof face a portion of the second main surface of the light guide plate, and
grooves are formed in the second main surface of the light guide plate.

9. A liquid crystal display device according to claim 8, wherein the grooves formed in the second main surface of the light guide plate are configured such that the depths of the grooves are increased corresponding to an increase of the distance from the light source at least in a range from the light source to one portion of the second main surface.

10. A liquid crystal display device according to claim 8, wherein the grooves formed in the second main surface of the light guide plate are configured such that the groove which is remotest from the light source has a depth larger than the depth of the groove which is arranged closest to the light source.

11. A liquid crystal display device according to claim 8, wherein the grooves formed in the second main surface of the light guide plate are configured such that the depth of the groove among the grooves in one portion of the second main surface which is arranged at a side more remote from the light source is larger than the depth of a neighboring groove in one portion of the second main surface of the light guide plate.

12. A liquid crystal display device according to claim 8, wherein the liquid crystal display device further includes a casing in which a first recessed portion for holding the first liquid crystal display panel, the light guide plate and the light source is formed in one side of the casing and a second recessed portion for holding the second liquid crystal display panel is formed in another side of the casing which faces the one side of the casing, an opening which allows the light radiated from the second main surface of the light guide plate to irradiate the main surface of the second liquid crystal display panel is formed between the first recessed portion and the second recessed portion, and one portion on the second main surface of the light guide plate is defined as a portion of the second main surface which faces the opening.

13. A liquid crystal display device comprising:
a first liquid crystal display panel having a main surface;
a second liquid crystal display panel having a main surface that is smaller than the main surface of the first liquid crystal display panel;
a light guide plate having a first main surface, a second main surface which faces the first main surface and side surfaces; and
a light source arranged at the side surface of the light guide plate, wherein
the first liquid crystal display panel is arranged to have the main surface thereof face the first main surface of the light guide plate,
the second liquid crystal display panel is arranged to have the main surface thereof face a portion of the second main surface of the light guide plate, and
on the second main surface of the light guide plate, at least one of the height and the depth with respect to the second main surface thereof and the density and the area in the inside of the second main surface differs between one portion of the second main surface and a peripheral portion close to said one portion.

14. A liquid crystal display device according to claim 13, wherein the liquid crystal display device further includes a casing in which a first recessed portion for holding the first liquid crystal display panel, the light guide plate and the light source is formed in one side of the casing, a second recessed portion for holding the second liquid crystal display panel is formed in another side of the casing which faces one side of the casing, an opening which allows light radiated from the second main surface of the light guide plate to irradiate the main surface of the second liquid crystal display panel is formed between the first recessed portion and the second recessed portion, and one portion on the second main surface of the light guide plate is defined as a portion of the second main surface which faces the opening.
